(19) United States
(12) Patent Application Publication
(10) Pub. No.: US 2009/0145405 A1
(43) Pub. Date: Jun. 11, 2009

(54) Jet for orifice damping

(76) Inventors: David Bonneau, Versailles (FR); Guillaume Trenado, Blois (FR)

Correspondence Address: DELPHI TECHNOLOGIES, INC., M/C 480-410-202, PO BOX 5052, TROY, MI, 48007, US

(21) Appl. No.: 12/316,258

(22) Filed: Dec. 10, 2008

(30) Foreign Application Priority Data
Dec. 10, 2007 (EP) 07122785.4

(51) Int. Cl. F02M 69/46

(52) U.S. Cl. 123/456; 123/446

(57) ABSTRACT

The present invention provides a jet for providing orifice damping in the fuel delivery system of a compression-ignition combustion engine, wherein the jet (100) is formed by means of a deep draw process and comprises a hollow cylindrical body (102) having first and second ends (104, 106), the first end (104) being open to enable unrestricted flow of fuel therethrough, in use, the second end (106) comprising an orifice (110) therein having a smaller cross-sectional area than the opening in the first end (104), to restrict the flow of fuel therethrough and dampen pressure waves in the fuel, in use, the second end (106) being shaped so as to provide resistance to pressure changes occurring in the fuel delivery system, in use.

### FIELD OF THE INVENTION

The present invention relates to a jet for providing orifice damping in the fuel delivery system of a compression-ignition combustion engine, a fuel delivery system for a compression-ignition combustion engine comprising such a jet, and to a method of manufacturing a jet for providing orifice damping in the fuel delivery system of a compression-ignition combustion engine.

### BACKGROUND OF THE INVENTION

In a known compression-ignition internal combustion engine, such as a diesel engine or gas engine, combustion takes place in one or more combustion chambers or cylinders. Air is compressed in the cylinder by a piston and fuel is injected into the compressed air. The heat of the compressed air spontaneously ignites the fuel in the cylinder.

Fuel is injected into the cylinders at high pressure, which is typically achieved using a high pressure pump to pressurise fuel in a rail cavity which, in turn, is connected to a plurality of injectors, each of which is associated with one cylinder of the engine.

FIG. 1 shows a conventional common rail delivery system 1 for a compression-ignition combustion engine. The rail 2 comprises an inlet pipe 4 into which fuel is pumped under high pressure by a high pressure pump 3. The rail 2 also includes a plurality of outlet pipes 5, one for each of the engine's cylinders, through which fuel is delivered to the injectors 6.

FIG. 2 is a sectional view of a conventional rail for a compression-ignition combustion engine. Referring to FIG. 2, the outlet 7 of each pipe 5 is connected to a fuel injector (not shown), which controls the flow of fuel into a corresponding engine cylinder.

Each injector typically comprises a nozzle through which fuel is injected into the corresponding cylinder. The flow of fuel through the injector nozzle is controlled by a valve needle which is movable along a primary axis of the injector body and may be lifted from a valve seat adjacent to the nozzle in order to allow fuel to flow through the nozzle and be injected into the cylinder.

In order to achieve efficient combustion in a cylinder it is important to be able to control the quantity and the timing of the fuel delivered to a cylinder. There is a problem with such high pressure fuel delivery systems that large pressure differences are caused by the opening and closing of the valve. For example, when the valve needle of the injector 6 is lifted into an injecting state, there is a large pressure difference between the rail 2 and the pressure at the injector 6. This pressure difference can cause pressure waves to travel along the pipes 5 connecting each injector 6 to the rail cavity 8. Such pressure waves are undesirable since they can affect the amount of fuel which is injected into a cylinder when the valve needle is lifted. For example, a pressure wave may result in unexpectedly high pressure at the nozzle, causing an increased amount of fuel to be injected into the cylinder when the valve is opened. This could lead to increased hydrocarbon emissions due to incomplete combustion of the fuel in the cylinder. Alternatively, a pressure wave may result in unexpectedly low pressure at the nozzle, causing less fuel than expected to be injected into the cylinder when the valve is opened. This may result in reduced engine power output.

A known technique for reducing the effect of pressure waves in the fuel delivery system is the inclusion of a jet, in the pipe 5 between the injector 6 and the rail cavity 8, in order to provide orifice damping.

FIG. 3 shows a conventional jet which is used to provide orifice damping in the fuel supplied by a rail to an injector in a diesel engine or gas engine. The known jet 10 is formed by machining a metal blank 12 having a substantially cylindrical form. An aperture or orifice 14 is formed in one end of the blank 12 such that the flow of fuel into the jet is restricted. An axial bore 16 is formed in the opposite end of the blank to create a conduit through which fuel flows from the rail 2 under pressure after it has passed through the orifice 14.

The reduction in the flow area of the fuel through the orifice 14 before it reaches the injector 6 has the effect of smoothing out any pressure waves which are propagating along the pipe 5 between the injector 6 and the rail 2. Accordingly, fluctuations in the amount of fuel injected when the injector valve is opened are reduced.

However, there is a problem with the conventional jet 10 in that it is expensive to manufacture. As mentioned above, the conventional jet 10 is formed by drilling a blank 12. Additional processing of the blank 12, such as grinding and heat treatment, may also be required. Each of these processing steps incurs a cost which contributes to the total cost of the finished jet.

It is therefore an object of the present invention to provide a jet for orifice damping in the fuel delivery system of a compression-ignition combustion engine which substantially overcomes or mitigates the problems associated with the conventional jet described above.

### SUMMARY OF INVENTION

According to a first aspect of the present invention, there is provided a jet for providing orifice damping in the fuel delivery system of a compression-ignition combustion engine, wherein the jet is formed by means of a deep draw process and comprises;
a hollow cylindrical body having first and second ends,
the first end being open to enable unrestricted flow of fuel therethrough, in use,
the second end comprising an orifice therein having a smaller cross-sectional area than the opening in the first end, to restrict the flow of fuel therethrough and dampen pressure waves in the fuel, in use, the second end being shaped so as to provide resistance to pressure changes occurring in the fuel delivery system, in use.

Thus, the present invention provides a jet which is simple and more economical to manufacture, yet is able to resist the changes of pressure which occur within the fuel delivery system of a compression-ignition combustion engine.

Preferably, the second end comprises a part-spherical region extending inwardly from a wall of the cylindrical body. Advantageously, said part-spherical region may project outwardly from the cylindrical body. Alternatively, said part-spherical region may project into the cylindrical body.

Preferably, said part-spherical region terminates in a flat region. More preferably, said orifice is formed within the flat region and is co-axial with the primary axis of the cylindrical body.

Advantageously, the jet comprises a pair of orifices in the part-spherical region, said pair of orifices being disposed at spaced apart locations equidistant from, and on opposite sides of the primary axis of the cylindrical-body.

Advantageously, the second end may alternatively comprise a flat region extending inwardly from and substantially perpendicularly to the wall of the cylindrical body. Said orifice may be formed in the flat region co-axial with the primary axis of the cylindrical body.

Advantageously, said flat region comprises a concentric rib or a cruciform rib.

The jet may advantageously comprise a pair of orifices in the flat region, said pair of orifices being disposed at spaced apart locations equidistant from, and on opposite sides of the primary axis of the cylindrical body.

Advantageously, the second end comprises a part-spherical region which projects from the flat region and terminates in a second flat region, said orifice being formed in the second flat region.

Advantageously, the part-spherical region projects outward from the cylindrical body. Alternatively, the part-spherical region may project into the cylindrical body.

According to a second aspect of the present invention, there is provided a fuel delivery system for a compression-ignition combustion engine, the system comprising a jet as described above;
a high pressure pump for pressurising fuel in the delivery system; and
a rail cavity for receiving pressurised fuel from the high pressure pump via an inlet pipe, the rail cavity having at least one outlet pipe for conveying fuel to at least one respective fuel injector.

Preferably, said jet is disposed in said outlet pipe or said inlet pipe. Alternatively, said jet may be disposed between said pump and said rail cavity. Advantageously, said jet may be formed integrally with any one of said high pressure pump, said rail cavity, said inlet pipe or said outlet pipe.

According to a third aspect of the present invention, there is provided a method of manufacturing a jet for providing orifice damping in the fuel delivery system of a compression-ignition combustion engine, the method comprising;
forming hollow a cylindrical body by means of a deep draw process,
the cylindrical body comprising first and second ends,
the first end being open to enable unrestricted flow of fuel therethrough, in use,
the second end comprising an orifice therein having a smaller cross-sectional area than the opening in the first end, to restrict the flow of fuel therethrough and dampen pressure waves in the fuel, in use, the second end being shaped so as to provide resistance to pressure changes occurring in the fuel delivery system, in use.

### BRIEF DESCRIPTION OF THE DRAWINGS

Embodiments of the present invention will now be described, by way of example, with reference to FIGS. 4 to 14 of the accompanying drawings, in which:

FIG. 1 shows a common rail fuel delivery system for a compression-ignition combustion engine;

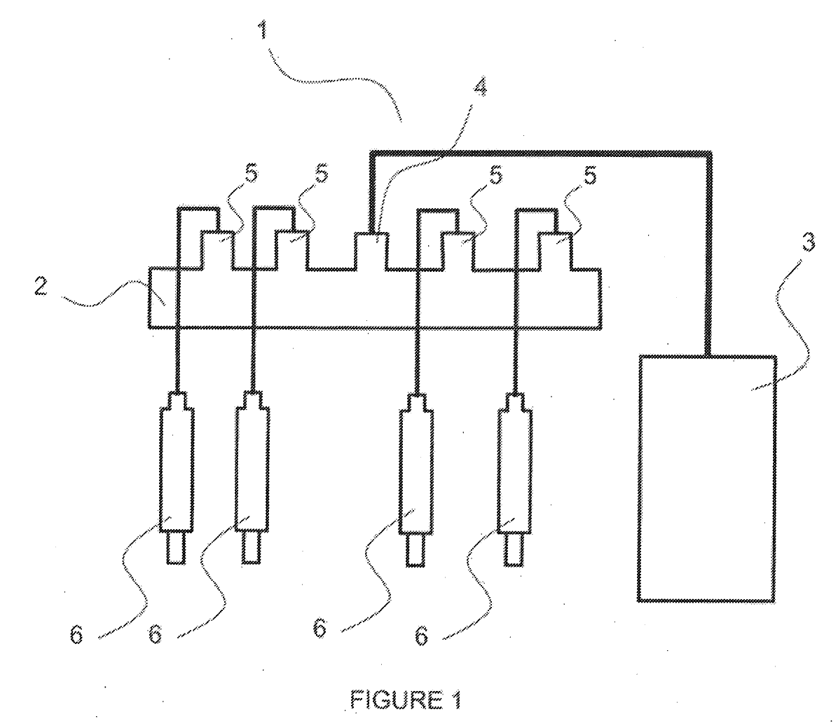

FIG. 2 is a sectional view of a conventional rail for a compression-ignition combustion engine;

FIG. 3 is a sectional view of a conventional jet for providing orifice damping in the rail of FIG. 2;

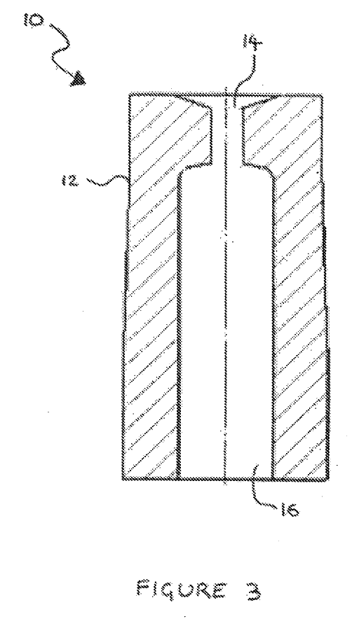

FIG. 4 is a perspective sectional view of a first embodiment of a jet according to the present invention;

FIG. 5 is a sectional view of the jet of FIG. 4;

FIG. 6 is a perspective sectional view of a second embodiment of a jet according to the present invention;

FIG. 7 is a perspective sectional view of a third embodiment of a jet according to the present invention;

FIG. 8 is a sectional view of the jet of FIG. 7;

FIG. 9 is a perspective sectional view of a fourth embodiment of a jet according to the present invention;

FIG. 10 is a sectional view of the jet of FIG. 9;

FIG. 11 is a perspective sectional view of a fifth embodiment of a jet according to the present invention;

FIG. 12 is a perspective sectional view of a sixth embodiment of a jet according to the present invention;

FIG. 13 is a perspective sectional view of a seventh embodiment of a jet according to the present invention; and

FIG. 14 is a perspective sectional view of a eighth embodiment of a jet according to the present invention.

### DETAILED DESCRIPTION OF THE PREFERRED EMBODIMENTS

A deep draw metal forming process is generally performed by stretching sheet metal stock around a punch. The sheet metal is clamped around its edges and is pressed into a die cavity by the punch in order to create a product having the desired shape. In this way, different shapes of product can be produced by varying the respective geometries of the die cavity and the punch.

By means of the above-described deep draw process, it is possible to produce jets which can withstand the large variations in pressure which occur within a common rail fuel delivery system. More specifically, it is known that during running of a compression-ignition combustion engine with a common rail fuel delivery system the fluid pressure on the upstream side of the orifice of a jet (i.e. on the same side as the rail cavity) may be as much as 300 bar higher than the pressure on the downstream side of the orifice (i.e. on the injector side), when the injector valve opens. As will be described in more detail below, embodiments of the present invention provide jets formed using a deep draw process which are shaped so as to be sufficiently resistant to such pressure differences.

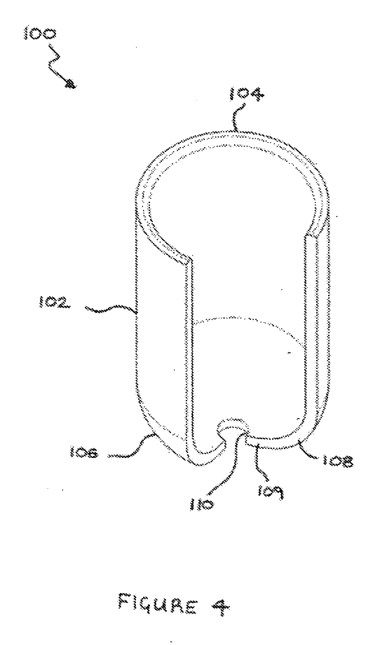

Referring to FIG. 4, a first embodiment of a deep drawn jet 100 according to the present invention comprises a generally cylindrical body 102. The cylindrical body 102 has an open end 104 at one end and is formed with a pressure resistant structure 106 at the opposite end. The pressure resistant structure 106 comprises a part-spherical portion 108 and a flat portion 109. The part-spherical portion 108 extends from the cylindrical body 102 with a constant radius, having its centre at a point on the primary axis (A-A) of the cylindrical body 102. The part-spherical portion 108 terminates at the flat portion 109. An orifice 110 is formed in the flat portion 109, the orifice 110 being co-axial with the primary axis of the cylindrical body 102.

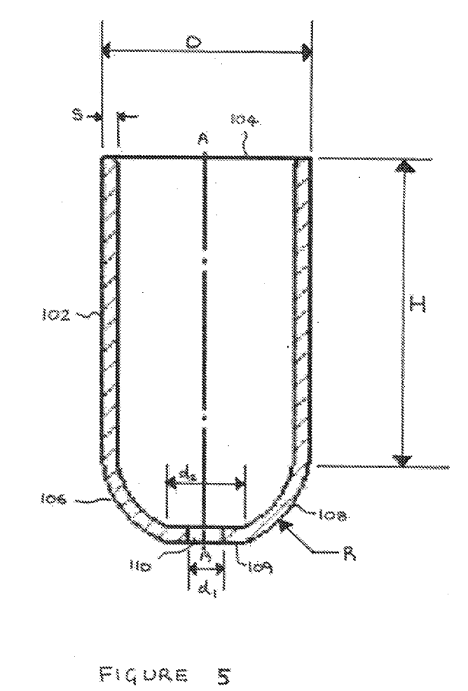

Referring to FIG. 5, the cylindrical body 102 has a wall thickness, s, which is equivalent to the thickness of the metal sheet stock from which the jet 100 is formed. The cylindrical body 102 has a height H, and diameter D and, typically, H=1 to 1.5D. The orifice 110 has a diameter d₁, the flat portion 109 has a diameter d₂, and the part-spherical portion 108 has radius R. Typically, d₂=1 to 1.5d₁ and R=D/2.

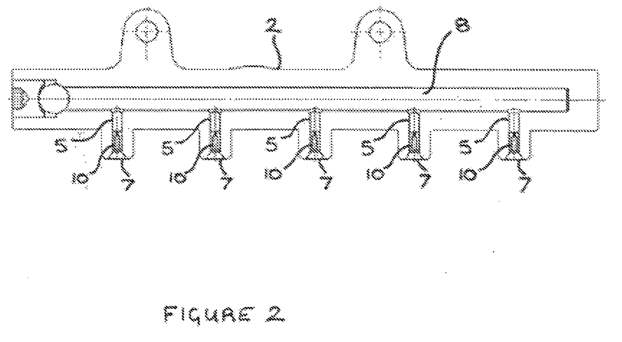

The jet 100 as shown in FIG. 4 is oriented with the open end 104 uppermost. In general, this is the orientation in which the jet 100 is formed by the deep draw process. More specifically, a suitably shaped metal blank is clamped around its edge and a punch presses the blank down into a suitably shaped die cavity. Accordingly, the open end 104 of the resulting jet 100 corresponds to the clamped part of the original metal blank, and the part-spherical portion 108 and flat portion 109 are formed between the punch and the bottom of the die cavity. However, it should be noted that, when installed in a fuel delivery system in place of the. conventional jet 10 shown in FIG. 2, the deep drawn jet 100 will be oriented in the pipe 5 such that the open end 104 is proximal to the injector and the part-spherical portion 108 is proximal to the rail cavity 8. Accordingly, in use, fuel will be pumped from the rail cavity 8, along the pipe 5 through the orifice 110 along the cylindrical body 102 of the jet 100 and out through the open end 104 to the injector 6.

A finite element analysis (FEA) of the deep drawn jet of FIG. 4 determined that it could withstand a pressure difference in excess of 1500 bar in the inlet direction of the jet, i.e. where there is a higher pressure on the rail side of the jet, and similarly a pressure difference in excess of 1500 bar in the outlet direction, i.e. where there is a higher pressure on the injector side of the jet.

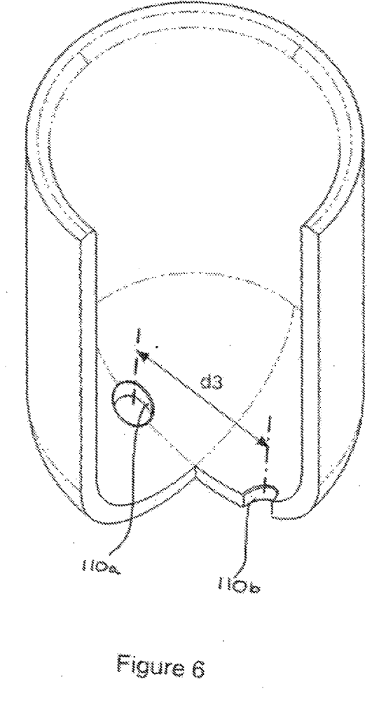

Referring to FIG. 6, a second embodiment of a jet according to the present invention is similar to that of FIGS. 4 and 5, with the exception that there is no flat portion 109 and instead of a single, co-axial orifice 110, there are a pair of orifices 110a, 110b. The pair of orifices 110a, 110b are formed in the part-spherical portion 108 at spaced apart locations, equidistant from, and on opposite sides of the primary axis of the cylindrical body 102. The distance between the orifices 110a, 110b is labelled d₃ in FIG. 6.

A finite element analysis (FEA) of the deep drawn jet of FIG. 6 determined that it could withstand a pressure difference in excess of 1500 bar in the inlet direction of the jet and similarly a pressure difference in excess of 1500 bar in the outlet direction.

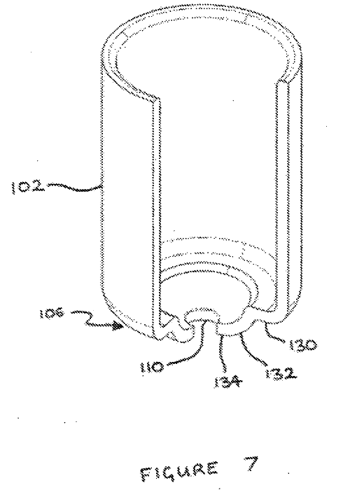

Referring to FIG. 7, the third embodiment of a jet according to the invention includes a pressure resistant structure 106 which has a bell-shape, comprising a first flat portion 130, a curved portion 132, and a second flat portion 134. The first flat portion 130 extends inwardly and radially from the edge of the cylindrical body 102. The curved portion 132 projects from the first flat portion 130 and terminates at the second flat portion 134. The curved portion 132 may have a radiussed or part-spheroidal form. An orifice 110 is formed in the second flat portion 134, the orifice 110 being co-axial with the primary axis of the cylindrical body 102.

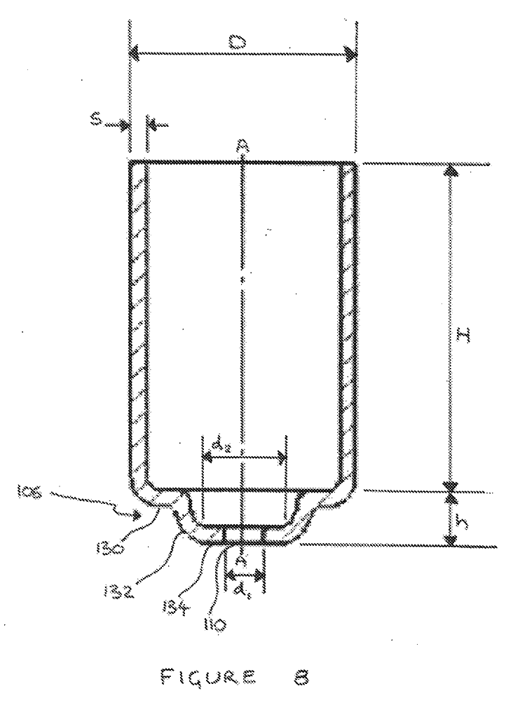

Referring to FIG. 8, the height of the cylindrical body 102 is H and the height of the pressure resistant structure 106, i.e. the combined height of the first and second flat portions 130,134 and the curved portion 132, is h. The wall thickness of the cylindrical body 102 is s. The diameter of the orifice 110 is d₁ and the diameter of the second flat portion 134 is d₂. Typically, H=1 to 1.5D, d₂=1 to 1.5d₁ and h=2 to 2.5s.

A finite element analysis (FEA) of the deep drawn jet of FIG. 7 determined that it could withstand a pressure difference of around 1200 bar in. the inlet direction of the jet and a pressure difference of around 1100 bar in the outlet direction.

In an alternative arrangement of the embodiment shown in FIG. 7, the bell-shaped portion may be inverted such that the curved portion 132 projects into the cylindrical body 102 of the jet 100.

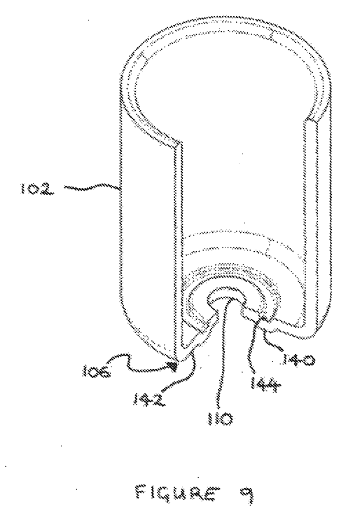

Referring to FIG. 9, the fourth embodiment of a jet according to the invention includes a pressure resistant structure 106 which comprises a concentric rib 140. The concentric rib 140 is co-axial with the primary axis of the cylindrical body 102, and is formed in a flat region 142 which extends inwardly and radially from the edge of the cylindrical body 102. The orifice 110 is disposed at the centre of the flat region 142 and is formed co-axially with the primary axis of the cylindrical body 102. The concentric rib 140 projects from the flat region 142 on the outer surface of the jet 100, and on the opposite side of the flat region 142 there is a correspondingly shaped trough 144.

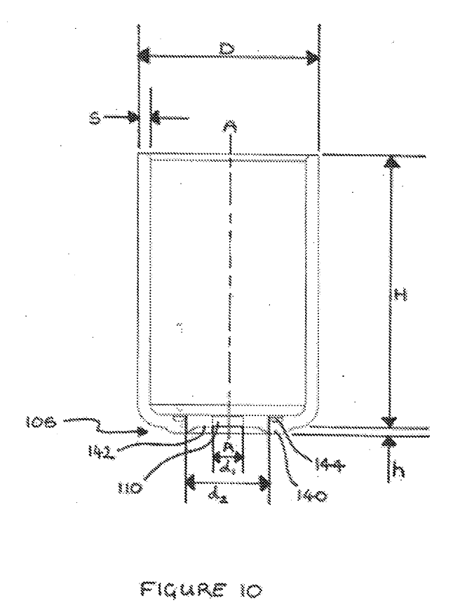

Referring to FIG. 10, the height of the cylindrical body 102 is H and the height of the pressure resistant structure 106, i.e. the height that the concentric rib 140 projects from the surface of the flat region 142, is h. The wall thickness of the cylindrical body 102 is s. The diameter of the orifice 110 is d₁ and the inner diameter of the concentric rib 140 is d₂. Typically, H=1 to 1.5D, d₂=1 to 1.5d₁ and h=0.5 to 0.75s.

A finite element analysis (FEA) of the deep drawn jet of FIG. 9 determined that it could withstand a pressure difference of around 800 bar in the inlet direction of the jet and a pressure difference of around 700 bar in the outlet direction.

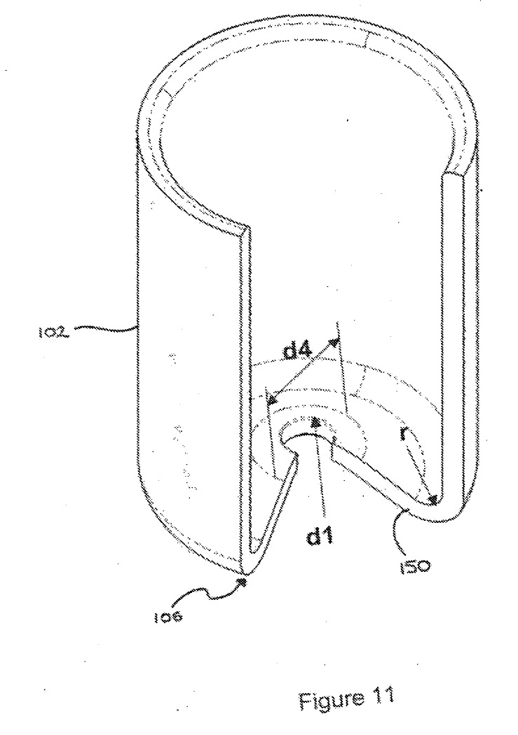

Referring to FIG. 11, the fifth embodiment of a jet according to the invention includes a pressure resistant structure 106 which comprises an inverted spherical shape 150. The fifth embodiment is similar to the first embodiment, with the exception that the spherical portion 150 projects into the cylindrical body 102 of the jet 100. In FIG. 11, the radius of curvature of the inverted spherical shape 150 is labelled r. The diameter of the orifice is labelled d₁ and the diameter of the central portion of the spherical shape is labelled d₄ and, typically, d₄=1 to 1.5d₁.

A finite element analysis (FEA) of the deep drawn jet of FIG. 11 determined that it could withstand a pressure difference of around 750 bar in the inlet direction of the jet and a pressure difference of around 850 bar in the outlet direction.

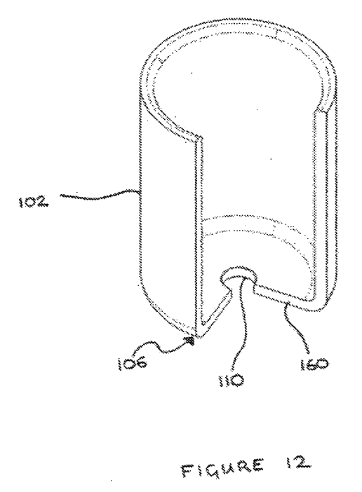

Referring to FIG. 12, the sixth embodiment of a jet according to the invention includes a pressure resistant structure 106 which comprises a flat region 160. The flat region 160 extends inwardly and radially from the edge of the cylindrical body 102. The orifice 110 is disposed at the centre of the flat region 160 and is formed co-axially with the primary axis of the cylindrical body 102.

A finite element analysis (FEA) of the deep drawn jet of FIG. 12 determined that it could withstand a pressure difference of around 650 bar in the inlet direction of the jet and a pressure difference of around 550 bar in the outlet direction.

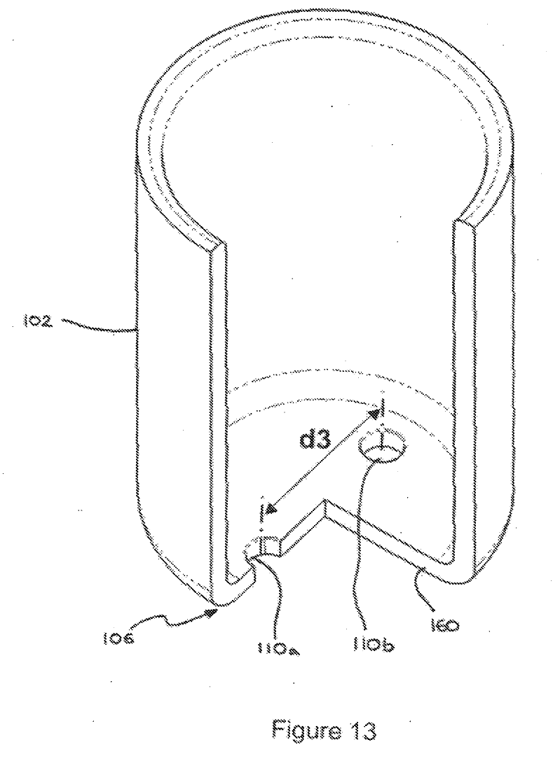

Referring to FIG. 13, the seventh embodiment of a jet according to the invention is similar to the above-described sixth embodiment with the exception that there are two orifices 110a, 110b in the flat region 160 rather than a single, centrally located orifice. The pair of orifices 110a, 110b are formed in the flat region 160 at spaced apart locations, equidistant from, and on opposite sides of the primary axis of the cylindrical body 102. The distance between the orifices 110a, 110b is labelled d₃ in FIG. 13.

A finite element analysis (FEA) of the deep drawn jet of FIG. 13 determined that it could withstand a pressure difference of around 600 bar in the inlet direction of the jet and a pressure difference of around 550 bar in the outlet direction.

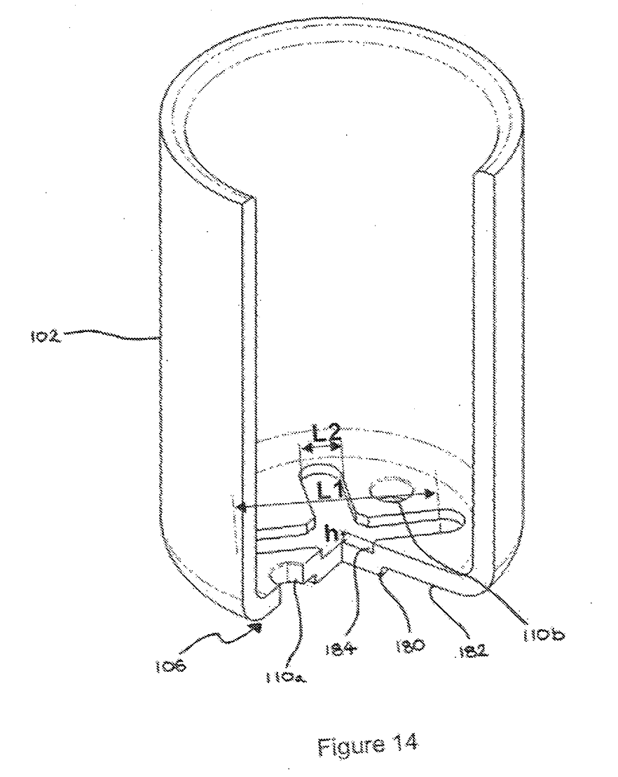

Referring to FIG. 14, the eighth embodiment of a jet according to the invention includes a pressure resistant structure 106 which comprises a cross-shaped rib 180. The cross-shaped rib 180 is centred on the primary axis of the cylindrical body 102, and is formed in a flat region 182 which extends inwardly and radially from the edge of the cylindrical body 102. A pair of orifices 110a, 110b are formed in the flat region 182 at spaced apart locations, equidistant from, and on opposite sides of the primary axis of the cylindrical body 102. The cross-shaped rib 180 projects from the flat region 182 on the outer surface of the jet 100, and on the opposite side of the flat region 182 there is a correspondingly shaped trough 184. In FIG. 14, the depth of the trough 184 is labelled h, and is equivalent to the distance which the rib 180 projects from the surface of the flat region 182. Each arm of the rib 180 has a length L₁ and a width L₂.

A finite element analysis (FEA) of the deep drawn jet of FIG. 14 determined that it could withstand a pressure difference of around 550 bar in the inlet direction of the jet and a pressure difference of around 550 bar in the outlet direction.

Although the jets according to the present invention have been described as for use between the rail cavity and the fuel injector of the fuel delivery system of a compression ignition combustion engine, it will be appreciated by those skilled in the art that such jets may advantageously be disposed at other locations within the fuel delivery system. For example, a jet may be disposed at the outlet of a high pressure pump used to pressurise fuel in the delivery system, at the inlet or outlets of the common rail volume, or at any other location where it is necessary to reduce the effects of pressure waves within the fuel flow.

It will be understood that the embodiments described above are given by way of example only and are not intended to limit the invention, the scope of which is defined in the appended claims.

1. A jet for providing orifice damping in the fuel delivery system of a compression-ignition combustion engine, wherein the jet (100) is formed by means of a deep draw process and comprises;
a hollow cylindrical body (102) having first and second ends (104,106),
the first end (104) being open to enable unrestricted flow of fuel therethrough, in use,
the second end (106) comprising an orifice (110) therein having a smaller cross-sectional area than the opening in the first end (104), to restrict the flow of fuel therethrough and dampen pressure waves in the fuel, in use, the second end (106) being shaped so as to provide resistance to pressure changes occurring in the fuel delivery system, in use.

2. A jet according to claim 1, wherein the second end (106) comprises a part-spherical region (108; 150) extending inwardly from a wall of the cylindrical body (102).

3. A jet according to claim 2, wherein said part-spherical region (108) projects outwardly from the cylindrical body (102).

4. A jet according to claim 2, wherein said part-spherical region (150) projects into the cylindrical body (102).

5. A jet according to any one of claims 2, 3 or 4, wherein said part-spherical region (108) terminates in a flat region (109).

6. A jet according to claim 5, wherein said orifice (110) is formed within the flat region (109) and is co-axial with the primary axis of the cylindrical body (102).

7. A jet according to any one of claims 2, 3 or 4, comprising a pair of orifices (110a, 110b) in the part-spherical region (108), said pair of orifices (110a, 110b) being disposed at spaced apart locations equidistant from, and on opposite sides of the primary axis of the cylindrical body (102).

8. A jet according to claim 1, wherein the second end (106) comprises a flat region (130; 142; 160; 182) extending inwardly from and substantially perpendicularly to the wall of the cylindrical body (102).

9. A jet according to claim 8, wherein said orifice (110) is formed in the flat region (140; 160) co-axial with the primary axis of the cylindrical body (102).

10. A jet according to claim 8 or 9, wherein said flat region (142) comprises a concentric rib (140).

11. A jet according to claim 8, wherein said flat region (182) comprises a cruciform rib (180).

12. A jet according to claim 8 or 11, comprising a pair of orifices (110a, 110b) in the flat region (160), said pair of orifices (110a, 110b) being disposed at spaced apart locations equidistant from, and on opposite sides of the primary axis of the cylindrical body (102).

13. A jet according to claim 8, wherein the second end (106) comprises a part-spherical region (132) which projects from the flat region (130) and terminates in a second flat region (134), said orifice (110) being formed in the second flat region (134).

14. A jet according to claim 13, wherein the part-spherical region projects outward from the cylindrical body (102).

15. A jet according to claim 13, wherein the part-spherical region projects into the cylindrical body (102).

16. A fuel delivery system for a compression-ignition combustion engine, the system comprising a jet (100) according to any preceding claim;
a high pressure pump (3) for pressurising fuel in the delivery system; and
a rail cavity (8) for receiving pressurised fuel from the high pressure pump (3) via an inlet pipe (4), the rail cavity (8) having at least one outlet pipe (5) for conveying fuel to at least one respective fuel injector (6).

17. A system according to claim 16, wherein said jet (100) is disposed in said outlet pipe (5) or said inlet pipe (4).

18. A system according to claim 16, wherein said jet (100) is disposed between said pump (3) and said rail cavity (8).

19. A system according to claim 16, wherein said jet (100) is formed integrally with any one of said high pressure pump (3), said rail cavity (8), said inlet pipe (4) or said outlet pipe (5).

20. A method of manufacturing a jet for providing orifice damping in the fuel delivery system of a compression-ignition combustion engine, the method comprising;
forming a hollow cylindrical body (102) by means of a deep draw process,
the cylindrical body (102) comprising first and second ends (104, 106),
the first end (104) being open to enable unrestricted flow of fuel therethrough, in use,
the second end (106) comprising an orifice (110) therein having a smaller cross-sectional area than the opening in the first end (104), to restrict the flow of fuel therethrough and dampen pressure waves in the fuel, in use, the second end (106) being shaped so as to provide resistance to pressure changes occurring in the fuel delivery system, in use.
